(19) United States
(12) Patent Application Publication
(10) Pub. No.: US 2012/0228795 A1
(43) Pub. Date: Sep. 13, 2012

(54) CERAMIC SUBSTRATE SUPPORTING MEMBER AND METHOD OF MANUFACTURING CERAMIC MEMBER

(75) Inventors: Seiji MINOURA, Gifu (JP); Toshiki Ito, Gifu (JP); Kazuhiro Ito, Gifu (JP)

(73) Assignee: IBIDEN CO., LTD., Gifu (JP)

(21) Appl. No.: 13/414,667

(22) Filed: Mar. 7, 2012

(30) Foreign Application Priority Data
Mar. 8, 2011 (JP) 2011-050303

(51) Int. Cl. B05C 13/02; B28B 11/04

(52) U.S. Cl. 264/131; 118/500

(57) ABSTRACT

There is provided a ceramic substrate supporting member configured to support a ceramic substrate at a tip portion thereof and used for forming a ceramic member coat on the ceramic substrate to manufacture a ceramic member in a reaction furnace. The ceramic substrate supporting member includes a core formed of graphite, and a supporting member coat formed at a surface including at least the tip portion with a pyrolytic carbon layer interposed between the core and the supporting member coat.

### CROSS-REFERENCE TO RELATED APPLICATION

This application claims priority from Japanese Patent Application No. 2011-050303, filed on Mar. 8, 2011, the entire subject matter of which is incorporated herein by reference.

### BACKGROUND OF THE INVENTION

1. Field of the Invention

The present invention relates to a ceramic substrate supporting member and a method of manufacturing a ceramic member.

2. Description of the Related Art

When coating a ceramic substrate of graphite or the like with a ceramic coat of SiC or the like by a CVD method to manufacture a ceramic member, the ceramic coat is not formed at a support point at which the ceramic substrate is supported. Accordingly, a method is employed where the position of the support point is varied and a multi-layered coat is formed. On the other hand, to enhance the productivity, there has been suggested a method of forming a coat at the support point with a single-layered coat. For example, there has been proposed a method of manufacturing a ceramic member in which a ceramic substrate is supported with a supporting pin having a coat formed of the same material as a ceramic coat and the coat remain at a support point of the ceramic substrate to coat the ceramic substrate (refer to JP S60-166286 A or JP 2005-213571 A).

Specifically, in the method of manufacturing a SiC-coated carbon member, which is disclosed in JP S60-166286 A, a supporting member formed of carbon has a cone shape or a pyramid shape and the surface having a graphite substrate placed on the top thereof is coated with SiC, Si, or Si₃N₄. The area of the top is set to be as small as possible so as not to destroy the carbon substrate, whereby the carbon substrate is uniformly coated with SiC.

In a vapor-deposited ceramic member and a method of manufacturing the vapor-deposited ceramic member, which is disclosed in JP 2005-213571 A, a supporting member has a cylinder shape, a polygonal pillar shape, a cone shape, or a polygonal pyramid shape and is coated with the same ceramic as the ceramic with which the ceramic member is coated.

The disclosures of JP 60-166286 A and JP 2005-213571 A are incorporated herein by reference.

However, those supporting members and those methods of manufacturing a ceramic member have the following problems. For example, as shown in FIG. 11 (or see JP 2005-213571 A), the method of manufacturing a ceramic member is carried out by supporting a graphite substrate (ceramic substrate) 501 with a ceramic substrate supporting pin (supporting pin) 505 having an SiC coat (supporting member coat) on the surface thereof, forming an SiC coat on the graphite substrate 501 and the supporting pin 505 by a CVD method, and then removing the supporting pin 505. At this time, the tip 506 of the supporting pin 505 remains on the SiC coat (ceramic member coat) 507 formed on the graphite substrate 501 and becomes a part of the ceramic member coat 507. However, there is a problem in that it is not determined at which position the tip 506 of the SiC coat (supporting member coat) formed on the supporting pin is separated. In addition, when separating the supporting pin 505 from the ceramic member having the SiC-CVD coat formed thereon, there is a problem in that the tip 506 of the supporting pin 505 might be not separated in a desired shape and the ceramic member coat 507 on the graphite substrate 501 might be reduced in thickness or completely removed to expose the graphite substrate 501. There is also a problem in that the supporting member coat on the supporting pin 505 might form a large protrusion which remains in the ceramic member coat 507 on the graphite substrate 501.

### SUMMARY OF THE INVENTION

Accordingly, an aspect of the present invention provides a ceramic substrate supporting member and a method of manufacturing a ceramic member, which can cause a supporting member coat to remain on a ceramic substrate (SiC-coated graphite member) to obtain a ceramic member having less defects such as pin holes.

According to an illustrative embodiment of the present invention, there is provided a ceramic substrate supporting member configured to support a ceramic substrate at a tip portion thereof and used for forming a ceramic member coat on the ceramic substrate to manufacture a ceramic member in a reaction furnace. The ceramic substrate supporting member includes a core formed of graphite, and a supporting member coat formed at a surface including at least the tip portion with a pyrolytic carbon layer interposed between the core and the supporting member coat.

According to the above configuration, the ceramic substrate supporting member includes the core formed of graphite, the surface of the graphite core is coated with pyrolytic carbon, and the surface is further coated with the supporting member coat. Since the pyrolytic carbon has no pores, the supporting member coat does not permeate the pyrolytic carbon layer when coating the pyrolytic carbon with the supporting member coat. Accordingly, it is possible to reduce the adhesive force between the supporting member coat and the pyrolytic carbon layer. When removing the ceramic substrate supporting member from the ceramic member having the ceramic member coat formed on the ceramic substrate, both are easily separated from each other at the location (that is, a predetermined location) between the pyrolytic carbon layer of the ceramic substrate supporting member and the supporting member coat. Accordingly, unevenness is not easily formed in the ceramic member coat on the ceramic substrate due to the exposure of the ceramic substrate from the ceramic member or the increase in the amount of the supporting member coat of the ceramic substrate supporting member remaining on the surface of the ceramic member coat formed on the ceramic substrate.

According to another illustrative embodiment of the present invention, there is provided a method of manufacturing a ceramic member including a ceramic substrate and a ceramic coat. The method includes preparing a ceramic substrate supporting member including a core formed of graphite, and a supporting member coat formed at a surface including at least a tip portion of the ceramic substrate supporting member with a pyrolytic carbon layer interposed between the core and the supporting member coat, forming a ceramic member coat on the ceramic substrate and the ceramic substrate supporting member while supporting the ceramic substrate with the tip portion of the ceramic substrate supporting member in a reaction furnace; and separating the ceramic substrate supporting member from the ceramic substrate.

According to the above method, the ceramic substrate supporting member includes the core formed of graphite, the surface of the graphite core is coated with pyrolytic carbon, and the pyrolytic carbon layer is coated with the supporting member coat. Since the pyrolytic carbon of the ceramic substrate supporting member has no pores, the supporting member coat does not permeate the pyrolytic carbon layer when coating the pyrolytic carbon layer with the supporting member coat. Accordingly, it is possible to reduce the adhesive force between the supporting member coat and the pyrolytic carbon layer. When separating the ceramic substrate supporting member from the ceramic member having the ceramic member coat formed thereon, both are easily separated from each other at the location (that is, predetermined location) between the pyrolytic carbon layer of the ceramic substrate supporting member and the supporting member coat. Accordingly, unevenness is not easily formed in the ceramic coat formed on the ceramic substrate due to the exposure of the ceramic substrate or an excessive decrease in the amount of the supporting member coat remaining.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 is a cross-sectional view illustrating a state where a ceramic member coat of a ceramic member is formed using a ceramic substrate supporting member according to Embodiment 1 of the present invention;

FIGS. 2A to 2D are diagrams illustrating the process of a manufacturing method using the ceramic substrate supporting member according to Embodiment 1;

FIG. 3 is a cross-sectional view illustrating a state where a ceramic member coat of a ceramic member is formed using a ceramic substrate supporting member according to Embodiment 2 of the present invention;

FIGS. 4A to 4D are diagrams illustrating the process of a manufacturing method using the ceramic substrate supporting member according to Embodiment 2;

FIG. 5 is a cross-sectional view illustrating a state where a ceramic member coat of a ceramic member is formed using a ceramic substrate supporting member according to a comparative example;

FIGS. 6A to 6D2 are diagrams illustrating the process of a manufacturing method using the ceramic substrate supporting member according to the comparative example;

FIG. 7A is a scanning electron microscope (SEM) photograph of a separated part of a ceramic member according to Embodiment 2, and FIG. 7B is a scanning electron microscope (SEM) photograph of a separated part of a ceramic substrate supporting member according to Embodiment 2;

FIGS. 8A and 8B are diagrams schematically illustrating the photographs of FIGS. 7A and 7B;

FIG. 9A is a scanning electron microscope (SEM) photograph of a separated part of a ceramic member according to the comparative example, and FIG. 9B is a scanning electron microscope (SEM) photograph of a separated part of a ceramic substrate supporting member according to the comparative example;

FIGS. 10A and 10B are diagrams schematically illustrating the photographs of FIGS. 9A and 9B; and

FIG. 11 is a diagram illustrating a method of manufacturing a ceramic member using a related-art ceramic substrate supporting member.

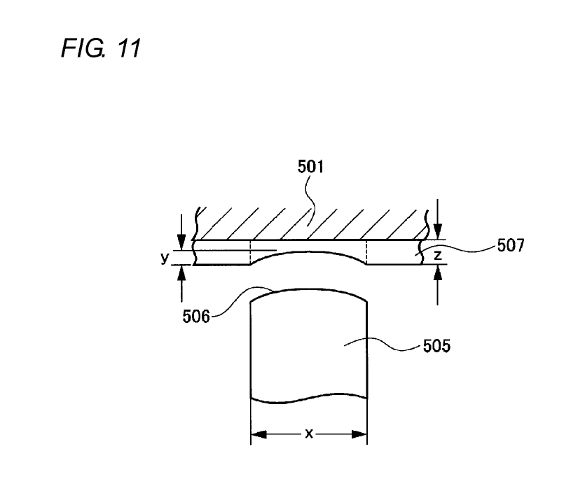

### DETAILED DESCRIPTION

In an embodiment of the present invention, the material of a ceramic substrate is not particularly limited, and may include, for example, graphite, carbon fiber reinforced carbon composite material, silicon carbide, zirconia, alumina, aluminum nitride, silicon nitride, boron carbide, boron nitride, and tantalum carbide. Among these, it is preferable that the ceramic substrate is formed of graphite. Graphite is flexible and can be machined in various forms. Since graphite is porous, the graphite strongly bonds to the ceramic member coat and thus the pyrolytic carbon layer of the tip portion of the ceramic substrate supporting member can be made to be easily separatable from the supporting member coat. Accordingly, the ceramic substrate supporting member can be suitably used to manufacture various heat treatment members (such as a susceptor) for manufacturing a semiconductor device.

In an embodiment of the present invention, the materials of a ceramic member coat and a supporting member coat are not particularly limited. The ceramic member coat and the supporting member coat can be formed of any of silicon carbide, boron nitride, silicon nitride, and tantalum carbide, as long as it can form a coat by a CVD method. The materials of the ceramic member coat and the supporting member coat may be same or may be different from each other, but they are preferably formed of the same material. The same material means that the major components of the ceramic member coat and the supporting member coat are the same.

Hereinafter, Embodiment 1 of the present invention will be described with reference to the accompanying drawings.

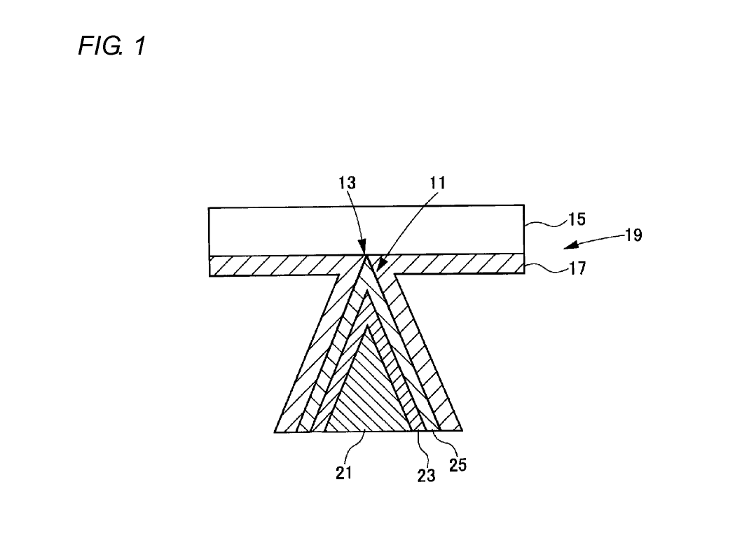

FIG. 1 is a diagram illustrating a state where a ceramic member coat of a ceramic member is formed using a ceramic substrate supporting member according to Embodiment 1 of the present invention.

A ceramic substrate supporting member 11 according to this embodiment is used to support a ceramic substrate 15 with a tip portion 13 and to form a ceramic member coat 17 on the ceramic substrate 15 in a reaction furnace to manufacture a ceramic member 19. The core 21 of the ceramic substrate supporting member 11 is formed of graphite. The core 21 is formed in a pin shape having a sharp tip portion 13. The ceramic substrate supporting member 11 is formed, for example, in a substantially cone shape or a substantially pyramid shape. The substantially cone-shaped or substantially pyramid-shaped tip portion 13 does not have a flat surface but has a sharp shape.

The ceramic substrate supporting member 11 has a supporting member coat 25 with a pyrolytic carbon layer 23, which is formed on the surface including at least the tip portion 13, interposed between the core 21 and the supporting member coat 25. Since the pyrolytic carbon layer 23 of the ceramic substrate supporting member has a columnar structure and has a dense composition without a pore, it is possible to prevent the permeation of CVD gas. Since the CVD gas does not permeate the pyrolytic carbon layer 23 of the ceramic substrate supporting member, the pyrolytic carbon layer 23 and the supporting member coat 25 of the ceramic substrate supporting member form a clear interface therebetween. Accordingly, the pyrolytic carbon layer 23 of the ceramic substrate supporting member has separability from the supporting member coat 25.

The material of the supporting member coat 25 coating the core 21 of the ceramic substrate supporting member 11 is preferably same as that of the ceramic member coat 17 coating the ceramic substrate 15. When separating the ceramic substrate supporting member 11 from the ceramic member 19, the tip portion 13 (supporting member coat) of the ceramic substrate supporting member which is removed from the ceramic substrate supporting member 11 and which remains on the ceramic substrate 15 is formed of the same material as the ceramic member coat 17 coating the ceramic substrate 15. Accordingly, minute cracks are less easily formed in the ceramic substrate 15 due to the difference in thermal expansion between the ceramic member coat and the supporting member coat. This is because the ceramic substrate is surely coated with the ceramic coat.

The supporting member coat 25 is preferably formed of a carbide-based ceramic or a nitride-based ceramic. When the supporting member coat 25 is formed of a carbide-based ceramic, the reactivity with the pyrolytic carbon of the ceramic substrate supporting member is not sufficient at a coat-forming temperature (for example, about 800° C. to about 1400° C.) of the ceramic using the CVD. Accordingly, even when the ceramic substrate supporting member is repeatedly used, the pyrolytic carbon layer of the ceramic substrate supporting member does not degrade or is not consumed by reaction.

It is more preferable that the supporting member coat 25 is formed of silicon carbide. When the supporting member coat 25 is formed of silicon carbide, the ceramic substrate supporting member can be stably used in vacuum and at a high temperature. Since silicon carbide has a high covalent and has a high hardness, it is possible to prevent the chipping or abrasion of the tip portion of the ceramic substrate supporting member when loading it into a CVD furnace or the like. When silicon carbide is used, it is possible to obtain a coat excellent in high-temperature strength and abrasion resistance. Since the thermal expansion coefficient of silicon carbide is close to the thermal expansion coefficient of graphite of the core, cracks due to a rise in temperature are easily formed in the supporting member coat. When cracks are not easily formed in the supporting member coat, the abnormal growth of the ceramic member coat starting from chips of the removed supporting member coat is less easily generated.

The ceramic substrate 15 used to form the ceramic member 19 is formed of graphite. Since it is formed of graphite, the ceramic substrate 15 is flexible and is easily machined in various forms. Since graphite is porous, the ceramic substrate is strongly bonded to the ceramic member coat and the supporting member coat and the pyrolytic carbon layer formed on the tip portion of the ceramic substrate supporting member is easily separated. Therefore, the ceramic substrate supporting member can be used to manufacture various heating members (for example, susceptor) in manufacturing a semiconductor device.

The thickness of the supporting member coat 25 (silicon-carbide coat) of the ceramic substrate supporting member 11 is preferably in the range of about 1 to about 3 times the thickness of the ceramic member coat 17 coating the graphite substrate as the ceramic substrate. More preferably, the thickness of the supporting member coat 25 is in the range of about 1.5 to about 2 times the thickness of the ceramic member coat 17. When the thickness of the supporting member coat 25 is less than about 1 time the thickness of the ceramic member coat 17, it is not possible to form a coat with a sufficient thickness. When the thickness of the supporting member coat 25 is more than about 3 times the thickness of the ceramic member coat 17, excessive concave or convex portions are easily formed on the surface of the ceramic member coat 17 formed on the ceramic substrate, in the state where the supporting member coat 25 is separated from the ceramic substrate supporting member 11 and the supporting member coat at the tip of the ceramic substrate supporting member becomes a part of the ceramic member coat 17.

The supporting member coat is preferably formed by a CVD method. Since the ceramic coat formed by the CVD method has a dense structure, the ceramic coat has low gas permeability and protects the ceramic substrate from reactive gas, thereby preventing impurities from being discharged from the ceramic substrate.

The thickness of the pyrolytic carbon layer formed on the ceramic substrate supporting member 11 is preferably in the range of about 10 to about 200 μm. When the thickness of the pyrolytic carbon layer is less than about 10 μm, the core can be easily exposed from the tip portion of the ceramic substrate supporting member 11 by abrasion or the like. When the thickness of the pyrolytic carbon layer is more than about 200 μm, cracks can be easily formed in the pyrolytic carbon layer at the tip of the ceramic substrate supporting member 11 due to the difference in thermal expansion between the core and the pyrolytic carbon layer of the ceramic substrate supporting member 11.

The tip portion 13 of the ceramic substrate supporting member 11 has a shape sharp toward the ceramic substrate 15. Since the tip portion 13 of the ceramic substrate supporting member 11 is sharp, source gas of the ceramic member coat is supplied between the ceramic substrate supporting member 11 and the ceramic substrate 15, thereby obtaining a strong adhesive force.

Next, a method of manufacturing a ceramic member 19 using the ceramic substrate supporting member 11 will be described below.

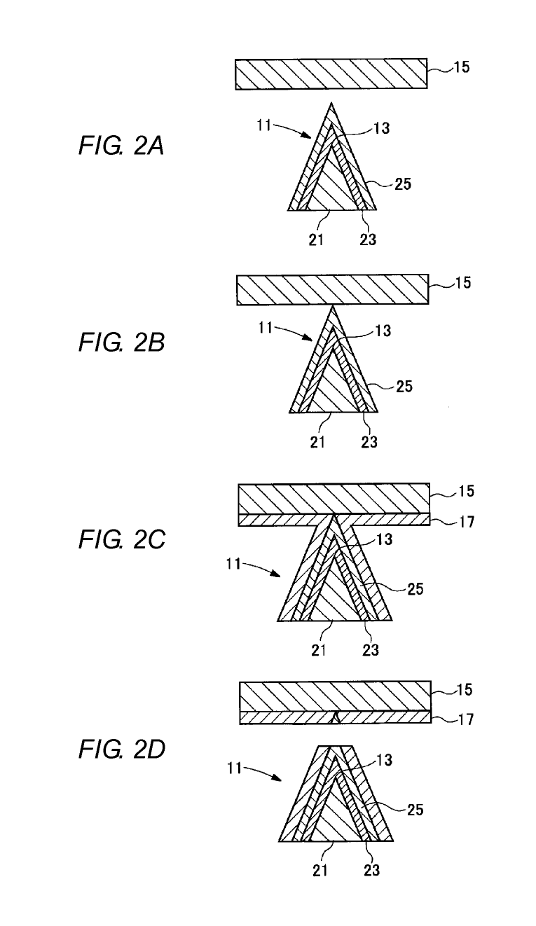

FIGS. 2A to 2D are diagrams illustrating the process of the method of manufacturing the ceramic member 19 using the ceramic substrate supporting member 11 according to Embodiment 1 of the present invention.

As shown in FIG. 2A, a ceramic substrate supporting member 11 having a core 21 formed of graphite and a supporting member coat 25 formed on the surface including at least a tip portion 13 with a pyrolytic carbon layer 23 interposed between the core 21 and the supporting member coat 25 is prepared. The temperature at which the supporting member coat 25 is formed on the core 21 of the ceramic substrate supporting member is, for example, in the range of about 1000° C. to about 1400° C.

As shown in FIG. 2B, a ceramic substrate 15 is supported with the tip portion 13 of the ceramic substrate supporting member 11.

As shown in FIG. 2C, a ceramic member coat 17 is formed on the ceramic substrate 15 supported with the tip portion 13 of the ceramic substrate supporting member 11 by coating the surface of the ceramic substrate 15 with SiC, Si₃N₄, or the like in a reaction furnace along with the ceramic substrate supporting member 11. The temperature at which the ceramic member coat 17 is formed on the ceramic substrate 15 is, for example, in the range of about 1000° C. to about 1400° C. At this time, by loading a graphite core having a pyrolytic carbon layer formed thereon into the furnace, it is possible to simultaneously prepared a ceramic substrate supporting member to be used in the next process.

As shown in FIG. 2D, after the surface of the ceramic substrate 15 and the surface of the ceramic substrate supporting member 11 are coated with the ceramic member coat 17, the ceramic substrate supporting member 11 is separated from the ceramic substrate 15. The separation is performed by folding the ceramic member 19 being supported with the ceramic substrate supporting member 11 and having the ceramic member coat 17 formed thereon by an application of a force to the ceramic substrate supporting member 11 so as to be bent and broken (in the horizontal direction in the drawing). Since the ceramic member and the ceramic substrate supporting member 11 are broken with a notch therebetween as a start point by the folding and separating, it is possible to reduce the area of the broken surface after separating the ceramic substrate supporting member 11. Accordingly, the supporting member coat 25 in the tip portion 13 of the ceramic substrate supporting member 11 is removed along with the ceramic member coat 17 formed on the ceramic substrate supporting member 11 with the boundary to the pyrolytic carbon layer 23 as a start point. The ceramic substrate supporting member 11 having the supporting member coat 25 separated from the tip portion 13 thereof can be reused (recycled) by removing the ceramic member coat and the supporting member coat, since the adhesive force between the pyrolytic carbon layer 23 and the supporting member coat 25 is weaker. In this way, the ceramic substrate supporting member obtained by removing the supporting member coat 25 of the tip portion 13 may be reused as the ceramic substrate supporting member 11.

Embodiment 2 of the present invention will be described below with reference to the accompanying drawings.

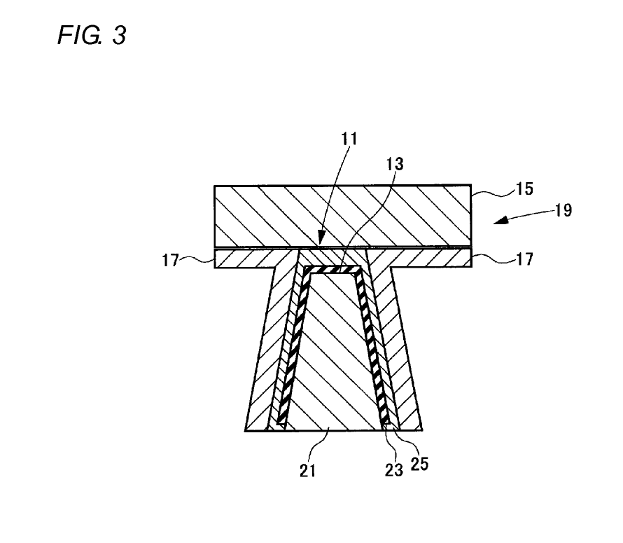

FIG. 3 is a diagram illustrating a state of a ceramic coat where a ceramic member coat of a ceramic member is formed using a ceramic substrate supporting member according to Embodiment 2 of the present invention.

A ceramic substrate supporting member 11 according to Embodiment 2 of the present invention is used to support a ceramic substrate 15 with a tip portion 13 and to form a ceramic member coat 17 on the ceramic substrate 15 in a reaction furnace to manufacture a ceramic member 19. In the ceramic substrate supporting member 11, the core 21 of the ceramic substrate supporting member 11 is formed of graphite. The ceramic substrate supporting member 11 has, for example, a substantially cone shape or a substantially pyramid shape. The core 21 is formed in a pin shape having a flat tip portion 13. The substantially cone-shaped or substantially pyramid-shaped tip portion 13 of the core has a flat surface within a circle with a diameter of about 0.5 mm or less in a plan view. When a flat surface within a circle with a diameter greater than about 0.5 mm is formed in the tip portion 13 of the core, the support area of the tip portion 13 of the ceramic substrate supporting member 11 in which the supporting member coat and the ceramic substrate come in contact with each other at a support point increases. Since source gas of the ceramic member coat hardly flows in the support area of the tip portion 13 of the ceramic substrate supporting member 11, the area of the support area not having the ceramic member coat increases and thus the supporting member coat is easily separated from the ceramic substrate to expose the ceramic substrate.

The surface of the ceramic substrate supporting member 11 including at least the tip portion 13 is coated with a supporting member coat 25 with a pyrolytic carbon layer 23 interposed between the core 21 and the supporting member coat 25. Since the pyrolytic carbon layer 23 has a columnar structure and has a dense composition without a pore, it is possible to prevent the permeation of CVD gas. Since the CVD gas does not permeate the pyrolytic carbon layer 23, the pyrolytic carbon layer 23 and the supporting member coat 25 form a clear interface therebetween. Accordingly, the pyrolytic carbon layer of the ceramic substrate supporting member 11 has separability from the supporting member coat 25.

The supporting member coat 25 coating the core 21 of the ceramic substrate supporting member 11 is preferably formed of the same material as the ceramic member coat 17 coating the ceramic substrate 15. When separating the ceramic substrate supporting member 11 from the ceramic member 19, the tip portion 13 of the ceramic substrate supporting member 11 which is removed from the ceramic substrate supporting member 11 and which remains on the ceramic member 19 is formed the same material as the ceramic member coat 17 with which the ceramic substrate 15 is coated. Accordingly, minute cracks are not easily formed in the ceramic substrate 15 due to the difference in thermal expansion between the ceramic member coat and the supporting member coat 25. Accordingly, the ceramic substrate 15 is sufficiently coated with the ceramic coat.

The supporting member coat 25 is preferably formed of a carbide-based ceramic or a nitride-based ceramic. When the supporting member coat 25 is formed of a carbide-based ceramic, the reactivity with the pyrolytic carbon of the ceramic substrate supporting member is not sufficient at a coat-forming temperature (for example, about 800° C. to about 1400° C.) of the ceramic using the CVD. Accordingly, even when the ceramic substrate supporting member is repeatedly used, the pyrolytic carbon layer does neither degrade nor reacts with the ceramic member and does not abrade the ceramic member.

The supporting member coat 25 may be formed of silicon carbide. When the supporting member coat 25 is formed of silicon carbide, the ceramic substrate supporting member can be stably used in vacuum and at a high temperature. Since silicon carbide has a high covalent and has a high hardness, it is possible to prevent the chipping or abrasion of the tip portion of the ceramic substrate supporting member when loading it into a CVD furnace or the like. When silicon carbide is used, it is possible to obtain a coat excellent in high-temperature strength and abrasion resistance. Since the thermal expansion coefficient of silicon carbide is close to the thermal expansion coefficient of graphite of the core, cracks due to a rise in temperature are not easily formed in the supporting member coat. When cracks are not easily formed in the supporting member coat, the abnormal growth of the ceramic member coat starting from chips of the removed supporting member coat is less easily generated.

The ceramic substrate 15 used to form the ceramic member 19 is formed of graphite. Since it is formed of graphite, the ceramic substrate 15 is flexible and is easily machined in various forms. Since graphite is porous, the ceramic substrate is strongly bonded to the ceramic member coat and the supporting member coat and the pyrolytic carbon layer formed on the tip portion of the ceramic substrate supporting member can be easily separated. Therefore, the ceramic substrate supporting member can be used to manufacture various heating members (for example, susceptor) in manufacturing a semiconductor device.

The thickness of the supporting member coat 25 (silicon-carbide coat) formed on the ceramic substrate supporting member 11 is preferably in the range of about 1 to about 3 times the thickness of the ceramic member coat 17 with which the graphite substrate as the ceramic substrate 15 is coated. The thickness of the supporting member coat 25 is more preferably in the range of about 1.5 to about 2 times the thickness of the ceramic member coat 17. When the thickness of the supporting member coat 25 is about 1 time less than the thickness of the ceramic member coat 17, it is not possible to form a coat with a sufficient thickness. When the thickness of the supporting member coat 25 is more than about 3 times the thickness of the ceramic member coat 17, excessive concave or convex portions are easily formed on the surface of the ceramic member coat 17 formed on the ceramic substrate 15, in the state where the supporting member coat 25 is separated from the ceramic substrate supporting member 11 and the supporting member coat at the tip of the ceramic substrate supporting member becomes a part of the ceramic member coat 17.

The core of the tip portion 13 of the ceramic substrate supporting member 11 is formed to have a flat surface perpendicular to an axis of the ceramic substrate supporting member. That is, since the core of the tip portion 13 of the ceramic substrate supporting member 11 is flat, the pyrolytic carbon layer 23 formed on the surface of the flat core is also flat. Accordingly, when separating the ceramic substrate supporting member 11 after the coating with the ceramic member coat 17, the tip portion of the core coated with the pyrolytic carbon can be made to be difficult to fold. Since the tip portion of the core coated with the pyrolytic carbon layer of the ceramic substrate supporting member does not remain on the ceramic member, it is not necessary to remove the tip portion again. Since the core coated with the pyrolytic carbon layer of the ceramic substrate supporting member is not changed from the original state, it is possible to repeatedly use the ceramic substrate supporting member by coating the core with a supporting member coat.

The thickness of the pyrolytic carbon layer 23 formed on the surface of the core of the tip portion 13 of the ceramic substrate supporting member 11 is preferably in the range of about 3 to about 100 μm. When the thickness of the pyrolytic carbon layer 23 formed on the surface of the core of the tip portion 13 of the ceramic substrate supporting member 11 is less than about 3 μm, the surface of the porous graphite substrate cannot be smoothed sufficiently and the supporting member coat is not removed from the pyrolytic carbon layer well. When the thickness of the pyrolytic carbon layer 23 formed on the surface of the core of the tip portion 13 of the ceramic substrate supporting member 11 is greater than about 100 μm, the radius of curvature of the edge portion around the flat surface formed on the tip portion 13 of the ceramic substrate supporting member 11 increases and the size of the flat surface formed on the top portion 13 of the ceramic substrate supporting member 11 decreases. Accordingly, a concave portion can be easily formed at the support point of the ceramic member.

The supporting member coat is preferably formed by a CVD method. Since the ceramic coat formed by the CVD method has a dense structure, the ceramic coat has low gas permeability and protects the ceramic substrate from reactive gas, thereby preventing impurities from being discharged from the ceramic substrate.

The thickness of the pyrolytic carbon layer formed on the ceramic substrate supporting member 11 is preferably in the range of about 10 to about 200 μm. When the thickness of the pyrolytic carbon layer formed on the ceramic substrate supporting member 11 is less than about 10 μm, the core can be easily exposed from the tip portion of the ceramic substrate supporting member 11 by abrasion or the like. When the thickness of the pyrolytic carbon layer formed on the ceramic substrate supporting member 11 is more than about 200 μm, cracks can be easily formed in the pyrolytic carbon layer at the tip of the ceramic substrate supporting member 11 due to the difference in thermal expansion between the core and the pyrolytic carbon layer of the ceramic substrate supporting member 11. The thickness of the pyrolytic carbon layer is still more preferably in the range of about 30 to about 100 μm.

Next, a method of manufacturing a ceramic member 19 using the ceramic substrate supporting member 11 according to Embodiment 2 will be described below.

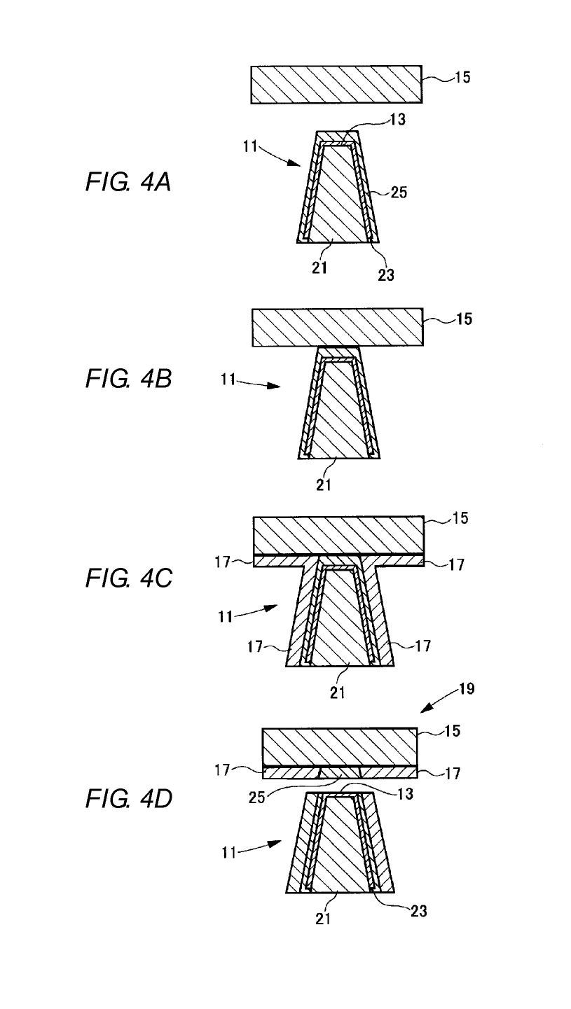

FIGS. 4A to 4D are diagrams illustrating the process of the method of manufacturing the ceramic member 19 using the ceramic substrate supporting member 11 according to Embodiment 2 of the present invention.

As shown in FIG. 4A, a ceramic substrate supporting member 11 having a core 21 formed of graphite and a supporting member coat 25 formed on the surface including at least a tip portion 13 with a pyrolytic carbon layer 23 interposed between the core 21 and the supporting member coat 25 is prepared. The temperature at which the supporting member coat 25 is formed on the core 21 of the ceramic substrate supporting member 11 is, for example, in the range of about 1000° C. to about 1400° C.

As shown in FIG. 4B, a ceramic substrate 15 is supported with the ceramic substrate supporting member 11.

As shown in FIG. 4C, a ceramic member coat 17 is formed on the ceramic substrate 15 supported with the ceramic substrate supporting member 11 by coating the surface of the ceramic substrate 15 with SiC, Si₃N₄, or the like in a reaction furnace along with the ceramic substrate supporting member 11. The temperature at which the ceramic member coat 17 is formed on the ceramic substrate 15 is, for example, in the range of about 1000° C. to about 1400° C. At this time, by loading a graphite core having a pyrolytic carbon layer formed thereon into the vessel, it is possible to simultaneously prepared a ceramic substrate supporting member to be used in the next process.

As shown in FIG. 4D, after the surface of the ceramic substrate 15 and the surface of the ceramic substrate supporting member 11 are coated with the ceramic member coat 17, the ceramic substrate supporting member 11 is separated from the ceramic substrate 15. The separation is performed by folding the ceramic member 19 being supported with the ceramic substrate supporting member 11 and having the ceramic member coat 17 formed thereon with an application of a force along the surface of the tip portion 13 of the ceramic substrate supporting member 11 so as to be bent and broken (in the horizontal direction in the drawing). Since the ceramic member and the ceramic substrate supporting member are broken with a notch therebetween as a start point by the folding and separating, it is possible to reduce the area of the broken surface after separating the ceramic substrate supporting member. Accordingly, the supporting member coat 25 in the tip portion 13 of the ceramic substrate supporting member 11 is removed along with the ceramic member coat 17 formed on the ceramic substrate supporting member 11 with the boundary to the pyrolytic carbon layer 23 as a start point. The ceramic substrate supporting member 11 having the supporting member coat 25 separated from the tip portion 13 thereof can be reused (recycled) by removing the ceramic member coat and the supporting member coat, since the supporting member coat can be easily removed from the pyrolytic carbon layer 23. In this way, the ceramic substrate supporting member 11 may be a ceramic substrate supporting member obtained by removing the supporting member coat 25 of the tip portion 13.

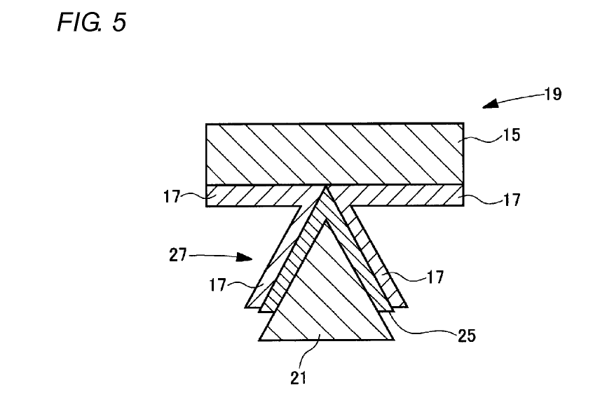

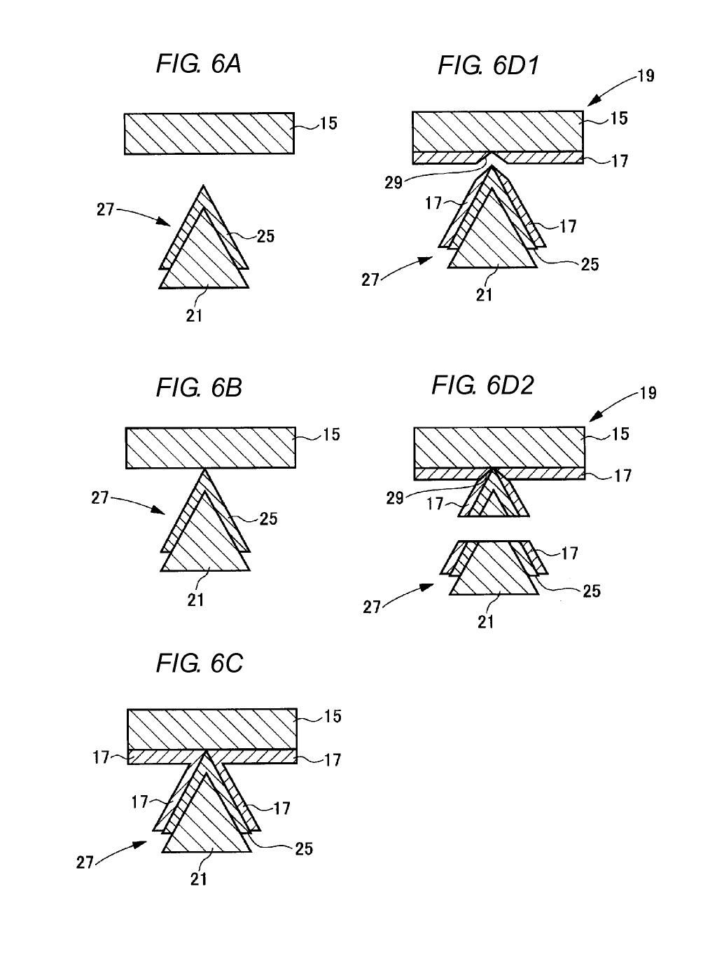

FIG. 5 is a cross-sectional view of a ceramic member coat 17 illustrating a state where the ceramic member coat 17 of a ceramic member 19 is formed using a ceramic substrate supporting member 27 according to a comparative example. FIGS. 6A to 6D1 and 6D2 are diagrams illustrating the process of a method of manufacturing the ceramic member 19 using the ceramic substrate supporting member 27 according to the comparative example.

Unlike Embodiments 1 and 2 of the present invention, the pyrolytic carbon layer 23 is not provided in the ceramic substrate supporting member 27 according to the comparative example shown in FIG. 5. Also, the flat tip portion 13 of the ceramic substrate supporting member is not formed. As shown in the comparative examples of FIGS. 6A to 6D1 and 6D2, when the process shown in FIGS. 6A to 6C which are the same as in Embodiment 1 are performed, the ceramic substrate 15 and the ceramic substrate supporting member 27 are coated with the ceramic member coat 17, and then the ceramic substrate supporting member 27 is separated from the ceramic substrate 15, there occurs a problem in that the ceramic substrate 15 is exposed from the bottom of the concave portion 29 (see FIG. 6D1) or in that the supporting member coat 25 becomes a large protrusion and remains in the ceramic member (see FIG. 6D2).

To the contrary, in the method of manufacturing the ceramic member 19 using the ceramic substrate supporting member 11 according to Embodiments 1 and 2, the core 21 of the ceramic substrate supporting member 11 is coated with the pyrolytic carbon layer 23 and the surface thereof is coated with the supporting member coat 25. Since the pyrolytic carbon layer 23 of the ceramic substrate supporting member 11 has no pores, the source gas of the supporting member coat 25 does not permeate the pyrolytic carbon layer when coating the ceramic substrate supporting member 11 with the supporting member coat 25. Accordingly, when the ceramic substrate 15 is coated with the ceramic member coat 17 to manufacture the ceramic member 19 and then the tip portion of the ceramic substrate supporting member 11 is folded, the pyrolytic carbon layer 23 and the supporting member coat 25 of the ceramic substrate supporting member 11 are easily separated from each other. By inserting the pyrolytic carbon layer 23 into the ceramic substrate supporting member 11, the supporting member coat 25 can be easily folded at the interface with the pyrolytic carbon layer, the ceramic substrate 15 is not exposed, and unevenness is not formed because the supporting member coat 25 excessively remains on the surface of the ceramic member 19 coated with the ceramic member coat 17.

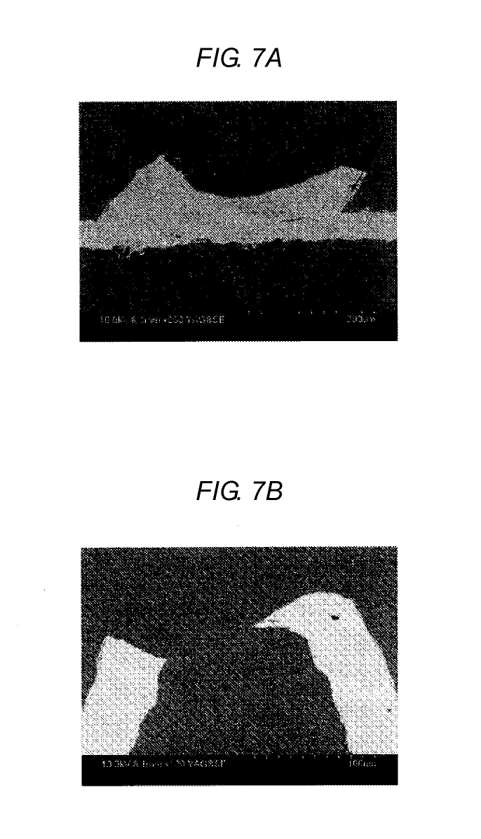

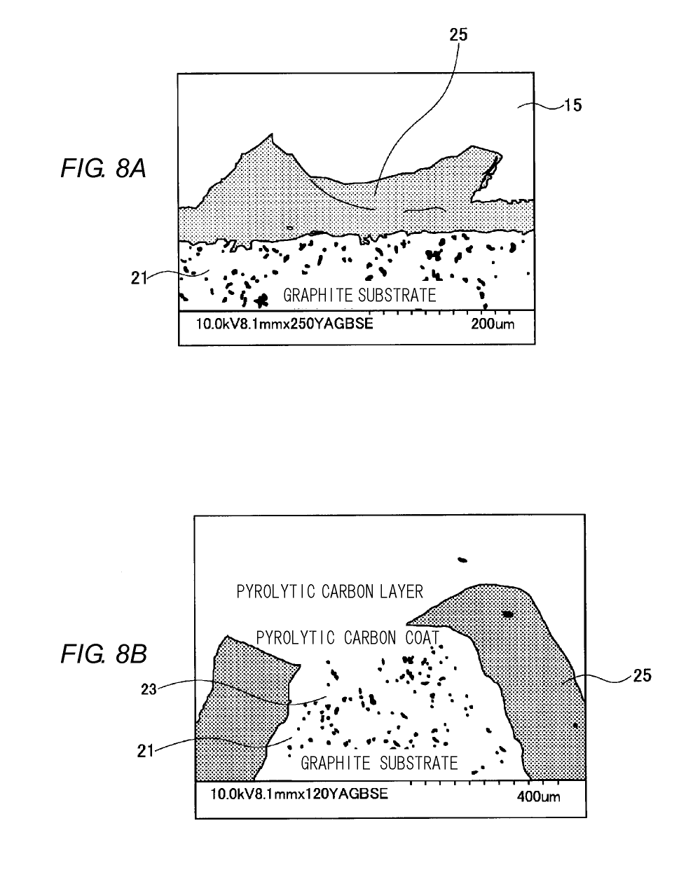

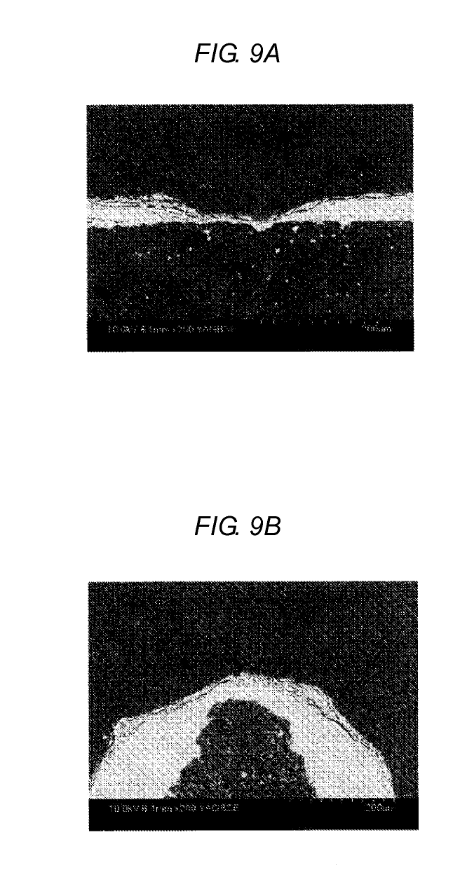

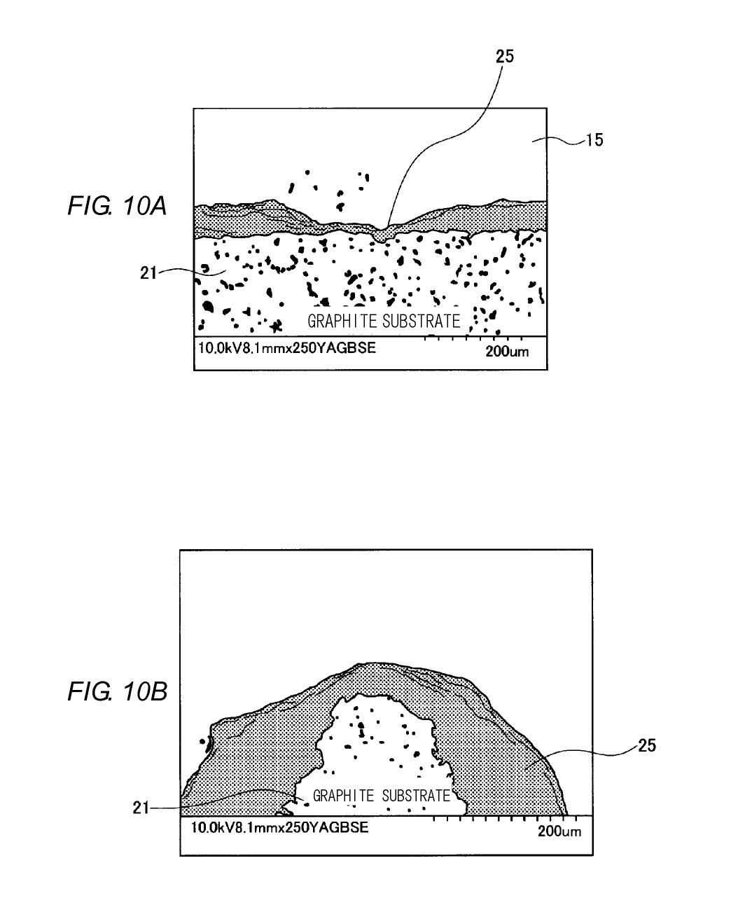

FIG. 7A is a scanning electron microscope (SEM) photograph of the separated part of the ceramic member 19 according to Embodiment 2 and FIG. 7B is a scanning electron microscope (SEM) photograph of the separated part of the ceramic substrate supporting member 11 according to Embodiment 2. FIGS. 8A and 8B are diagrams schematically illustrating the photographs of FIGS. 7A and 7B. FIG. 9A is a scanning electron microscope (SEM) photograph of the separated part of the ceramic member 19 according to the comparative example and FIG. 9B is a scanning electron microscope (SEM) photograph of the separated part of the ceramic substrate supporting member 27 according to the comparative example. FIGS. 10A and 10B are diagrams schematically illustrating the photographs of FIGS. 9A and 9B.

The observation results of the separated part of the ceramic member 19 obtained by the method of manufacturing the ceramic member according to Embodiment 2 and the tip portion 13 of the ceramic substrate supporting member 11 will be described below. In the embodiment shown in FIG. 7A, the supporting member coat 25 is sufficiently formed in the separated part. That is, unlike the comparative example (related art) shown in FIG. 9A, the supporting member coat 25 is not thinned.

In the ceramic substrate supporting member 11 separated from the ceramic member, the supporting member coat 25 is removed from the tip portion 13 and the pyrolytic carbon layer 23 is exposed, in Embodiment 2 shown in FIG. 7B. That is, unlike the comparative example (related art) shown in FIG. 9B, the supporting member coat 25 does not remain. Accordingly, in the ceramic substrate supporting member 11 according to Embodiment 2, the ceramic member coat and the supporting member coat around the tip portion of the ceramic substrate supporting member 11 can be removed and the tip portion can be newly coated with a supporting member coat 25 for the next process. Accordingly, a problem that the tip portion 13 increases in size for each reuse and cannot be finally does not occur.

Therefore, in the ceramic substrate supporting member 11 according to Embodiment 2, the supporting member coat 25 (the silicon carbide coat of the ceramic substrate supporting member) formed in the tip portion 13 of the ceramic substrate supporting member 11 supporting the ceramic substrate 15 (the graphite substrate coated with a silicon carbide coat) is formed on the core 21 with the pyrolytic carbon layer 23 interposed between the core 21 and the supporting member coat 25. Accordingly, it is possible to cause the supporting member coat 25 separated from the pyrolytic carbon layer 23 of the ceramic substrate supporting member 11 to sufficiently remain on the ceramic substrate 15 (SiC-coated graphite substrate).

By using the method of manufacturing the ceramic member 19 using the ceramic substrate supporting member 11 according to Embodiment 2, since the supporting member coat 25 (the silicon carbide coat of the ceramic substrate supporting member) formed on the tip portion 13 of the ceramic substrate supporting member 11 can be caused to sufficiently remain in the ceramic member coat 17 (SiC-coated graphite substrate) formed on the ceramic substrate 15, it is possible to obtain a ceramic member 19 having reduced defects such as cracks or protrusions at the support point.

In Embodiment 1, Embodiment 2, and the comparative example (related art), the methods of forming the pyrolytic carbon layer, the ceramic member coat, and the supporting member coat are not particularly limited and can employ general methods. For example, the coats can be formed using the following methods.

(Ceramic Member Coat)

A graphite core is loaded into a CVD furnace so as to expose the tip portion thereof, and the furnace is vacuumed and is raised in temperature. The coat-forming temperature in the furnace is maintained, for example, at a constant temperature in the range of about 800° C. to about 1400° C. Then, hydrogen as carrier gas and CH₃Cl₃Si as source gas are introduced into the furnace, and this atmosphere is maintained for several hours, whereby a ceramic member coat is deposited on the surface of the ceramic member and the graphite core. When CH₃Cl₃Si is used as the source gas, the ceramic member coat is formed of silicon carbide. The source gas is not limited to CH₃Cl₃Si but can be appropriately selected from typical source gas depending on the type of the ceramic member coat.

(Supporting Member Coat)

A ceramic substrate is supported with a ceramic substrate supporting member, the resultant is loaded into a CVD furnace, and the furnace is vacuumed and raised in temperature. The coat-forming temperature in the furnace is maintained, for example, at a constant temperature in the range of about 800° C. to about 1400° C. Then, hydrogen as carrier gas and CH₃Cl₃Si as source gas are introduced into the furnace, and this atmosphere is maintained for several hours, whereby a supporting member coat is deposited on the surface of the graphite core (the pyrolytic carbon layer is formed on the surface of the graphite core in Embodiment 1 and Embodiment 2). When CH₃Cl₃Si is used as the source gas, the supporting member coat is formed of silicon carbide. The source gas is not limited to CH₃Cl₃Si but can be appropriately selected from typical source gas depending on the type of the supporting member coat.

(Pyrolytic Carbon Layer)

A graphite core is loaded into a CVD furnace so as to expose the tip portion thereof, and the furnace is vacuumed and is raised in temperature. The coat-forming temperature in the furnace is maintained, for example, at a constant temperature in the range of about 1200° C. to about 2000° C. Then, hydrogen as carrier gas and hydrocarbon gas such as methane, ethane, and propane as source gas are introduced into the furnace, and this atmosphere is maintained for several hours, whereby a pyrolytic carbon layer is deposited on the surface of the graphite core.

It is noted that the pyrolytic carbon layer and the supporting member coat may be individually formed. The pyrolytic carbon layer and the supporting member coat may be sequentially formed in the same furnace in this order. When the pyrolytic carbon layer and the supporting member coat may be sequentially formed in the same furnace, the pyrolytic carbon layer is formed, then the temperature of the furnace is adjusted to the coat-forming temperature of the supporting member coat, and the source gas is changed, whereby they can be continuously formed. By continuously forming the pyrolytic carbon layer and the supporting member coat, it is possible to simplify the processing steps.

While the present invention has been shown and described with reference to certain illustrative embodiments thereof, it will be understood by those skilled in the art that various changes in form and details may be made therein without departing from the spirit and scope of the invention as defined by the appended claims.

What is claimed is:

1. A ceramic substrate supporting member configured to support a ceramic substrate at a tip portion thereof and used for forming a ceramic member coat on the ceramic substrate to manufacture a ceramic member in a reaction furnace, the ceramic substrate supporting member comprises:
a core formed of graphite; and
a supporting member coat formed at a surface including at least the tip portion with a pyrolytic carbon layer interposed between the core and the supporting member coat.

2. The ceramic substrate supporting member according to claim 1,
wherein the supporting member coat is formed of the same material as the ceramic member coat.

3. The ceramic substrate supporting member according to claim 1,
wherein the supporting member coat is formed of a carbide-based ceramic or a nitride-based ceramic.

4. The ceramic substrate supporting member according to claim 1,
wherein the supporting member coat is formed of silicon carbide.

5. The ceramic substrate supporting member according to claim 1,
wherein the core has a flat surface perpendicular to an axis of the ceramic substrate supporting member at the tip portion.

6. The ceramic substrate supporting member according to claim 1,
wherein the ceramic substrate is formed of graphite.

7. The ceramic substrate supporting member according to claim 1,
wherein the ceramic member is a heat treatment member for manufacturing a semiconductor device.

8. A method of manufacturing a ceramic member including a ceramic substrate and a ceramic coat, the method comprising:
preparing a ceramic substrate supporting member including a core formed of graphite, and a supporting member coat formed at a surface including at least a tip portion of the ceramic substrate supporting member with a pyrolytic carbon layer interposed between the core and the supporting member coat;
forming a ceramic member coat on the ceramic substrate and the ceramic substrate supporting member while supporting the ceramic substrate with the tip portion of the ceramic substrate supporting member in a reaction furnace; and
separating the ceramic substrate supporting member from the ceramic substrate.

9. The method according to claim 8,
wherein the supporting member coat is formed of the same material as the ceramic member coat.

10. The method according to claim 8,
wherein the supporting member coat is formed of a carbide-based ceramic or a nitride-based ceramic.

11. The method according to claim 8,
wherein the supporting member coat is formed of silicon carbide.

12. The method according to claim 8,
wherein the tip portion has a flat surface perpendicular to an axis of the ceramic substrate supporting member.

13. The method according to claim 8,
wherein the ceramic substrate is formed of graphite.

14. The method according to claim 8,
wherein the ceramic member is a heat treatment member for manufacturing a semiconductor device.

15. The method according to claim 12,
wherein the separating includes applying a force along the flat surface to break a part of the ceramic substrate supporting member.
